(19) United States
(12) Patent Application Publication
(10) Pub. No.: US 2014/0029123 A1
(43) Pub. Date: Jan. 30, 2014

(54) INTERIOR SIDE MIRROR FOR SIDE BLIND SPOT OF A CAR

(71) Applicant: SHANGHAI INSTITUTE OF MICROSYSTEM AND INFORMATION TECHNOLOGY, CHINESE ACADEMY, (unknown)

(72) Inventors: DAVY ZIDE QIAN, Arcadia, CA (US); BENYU QIAN, SHANGHAI (CN); LEQUN LU, Shanghai (CN)

(21) Appl. No.: 13/954,401

(22) Filed: Jul. 30, 2013

Related U.S. Application Data
(60) Provisional application No. 61/677,021, filed on Jul. 30, 2012.
(60) Provisional application No. 61/719,525, filed on Oct. 29, 2012.
(60) Provisional application No. 61/746,100, filed on Dec. 26, 2012.

(51) Int. Cl. B60R 1/00

(52) U.S. Cl. CPC B60R 1/007
USPC 359/844

(57) ABSTRACT

An interior side mirror for side blind spot of a car comprises a base fixed on the dash board or side door of the car, a side mirror, a flexible bar for connecting the base with the side mirror. The base and flexible bar locate the mirror at a best place before a driver, let the driver can view the side blind spot without turning head. The base can be anchor base or sand bag base or cardboard base or silicone sticky pad base. The flexible bar can be a ball-socket joint flexible bar or a flexible metal conduit bar. The mirror can be adjusted to a best place to reflect the blind spot.

### CROSS REFERENCE TO RELATED PATENT APPLICATION

This application claims the priorities of the U.S. provisional application No. 61/677,021 filed on Jul. 30, 2012, U.S. provisional application No. 61/719,525 filed on Oct. 29, 2012 and U.S. provisional application No. 61/746,100 filed on Dec.26, 2012, which applications are incorporated herein by reference.

### FIELD OF THE INVENTION

The present invention relates to side mirror assemblies, and more particularly to an interior side mirror for side blind spot.

### BACKGROUND OF THE INVENTION

Every driver knows the side blind spot. When changing lane the driver must turn head to view the side blind spot to know if vehicles are existed. If the driver forgets to do it, car crash accident may be happen. Returning head to view the side blind spot is very important but brings tire to the driver. Many inventions want to solve this problem, but these inventions are complex, and expensive. Some of them are simple and used with an exterior side mirror, but the image of the blind spot is small, driver cannot see it clearly.

### SUMMARY OF THE INVENTION

The purpose of the present invention is to provide an interior side mirror for side blind spot to assist driver viewing the side blind spot without returning head.

An interior side mirror for side blind spot of a car comprising a base fixed on an interior part of the car before a driver; a side mirror; and a flexible bar for connecting the base with the side mirror; the side mirror can be placed a best position for the driver viewing the side blind spot without turning head.

The interior side mirror has a base is an anchor base, which has a plate, a neck is on the plate and a ball is supported by the neck, a plurality of anchor legs are extended from a back of the plate, the plurality of anchor legs are inserted into an side AC vent window to fix the anchor base therein.

The base of the interior side mirror for side blind spot can be a sand bag base, which is sit on a dash board beside the driver by weight, the side mirror is fixed on a flexible metal conduit which is fixed on the sand bag.

The base of the interior side mirror for side blind spot can be a cardboard base having adhesive tape, which is stuck on a dash board beside the driver, the side mirror is fixed on a flexible metal conduit which is fixed on the cardboard base.

The base of the interior side mirror for side blind spot can be a silicone sticky pad base having adhesive tape, which is stuck on a dash board beside the driver, the side mirror is fixed on a ball-socket joint flexible bar which is fixed on the silicone sticky pad.

The present invention of interior side mirror for side blind spot is very important for drivers. It can solve the problem of the common side mirror cannot view the side blind spot, it can release driver's fatigue gotten from returning head and help improve driving safety.

### BRIEF DESCRIPTION OF THE DRAWINGS

FIG. 1 shows the interior side mirror for side blind spot, which has anchor base fixed on a side AC vent window.

FIG. 2 shows the anchor base of the interior side mirror for side blind spot.

FIG. 3 shows the anchor base is fixed on the side AC vent window by its three anchor legs.

FIG. 4 shows the ball-socket joint flexible bar of the interior side mirror for side blind spot.

FIG. 5 shows the side mirror being connected with the ball-socket joint flexible bar.

FIG. 6 shows the interior side mirror for side blind spot is fixed on the side AC vent window by the anchor base.

FIG. 7 shows the side mirror connected with the ball-socket joint flexible bar.

FIG. 8 shows the interior side mirror for side blind spot, which has a sand bag base sit on a dash board.

FIG. 9 shows the interior side mirror for side blind spot, which has a cardboard base having adhesive tape.

FIG. 10 shows the interior side mirror for side blind spot with a cardboard base, which is stuck on the dash board of the car.

FIG. 11 shows the interior side mirror for side blind spot with a flexible cardboard base, which is stuck on the side door of the car.

FIG. 12 shows the interior side mirror for side blind spot with a silicone sticky pad base, which is stuck on the dash board of the car.

FIG. 13 shows the silicone sticky pad.

### DETAIL DESCRIPTION OF THE INVENTION

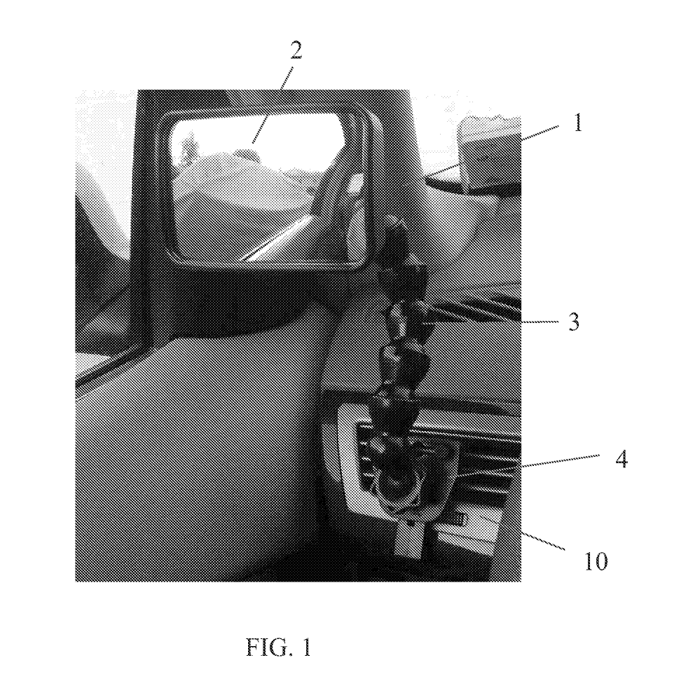

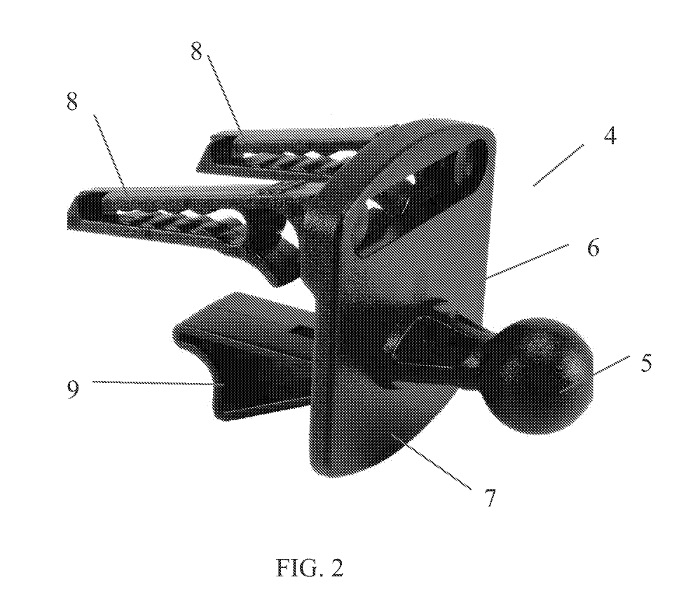

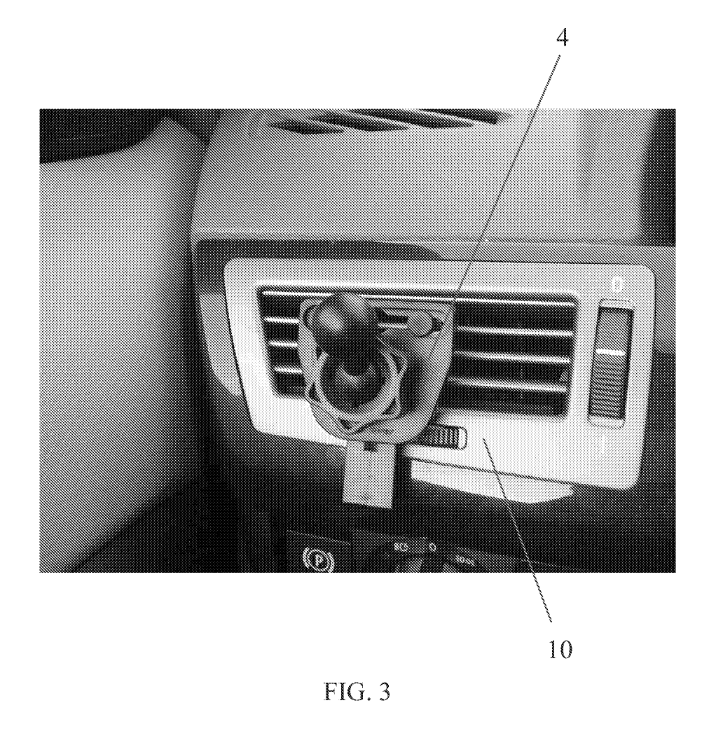

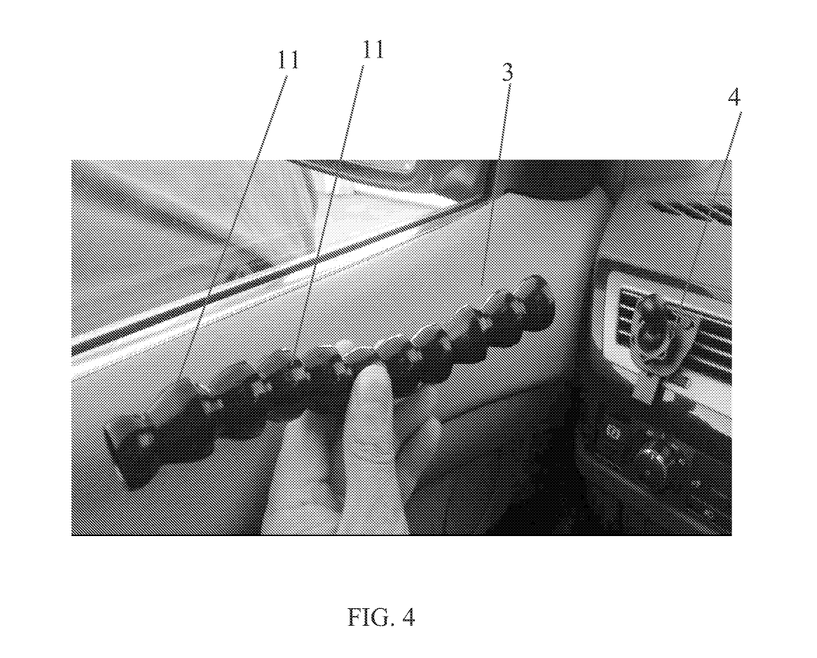

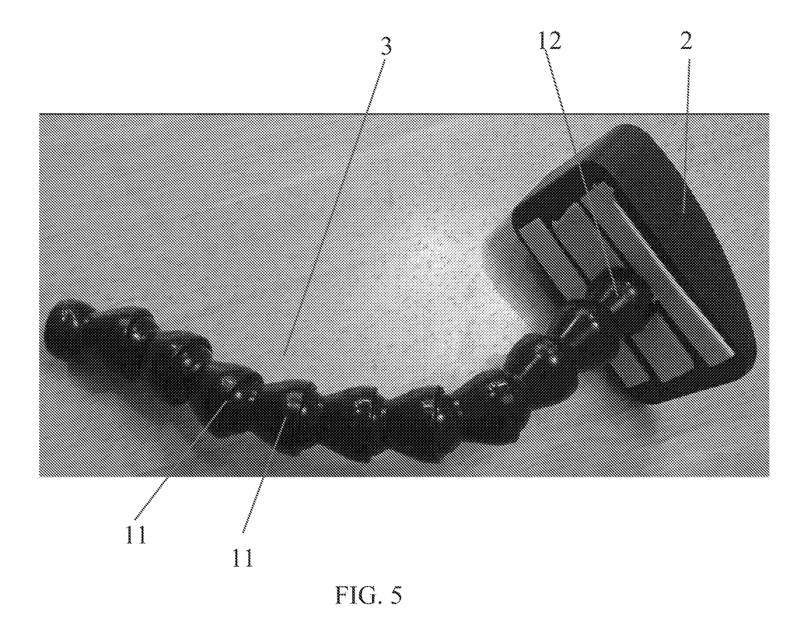

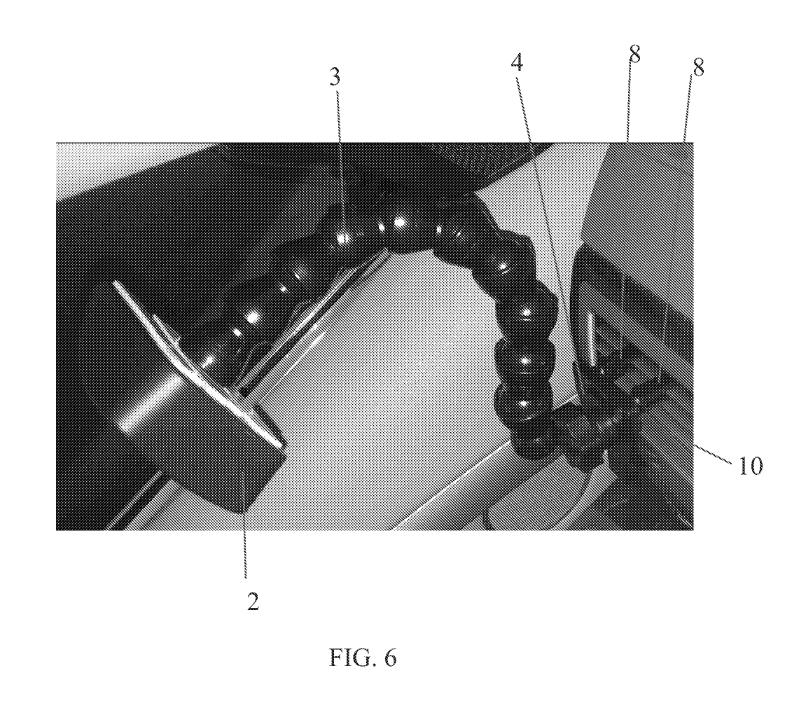

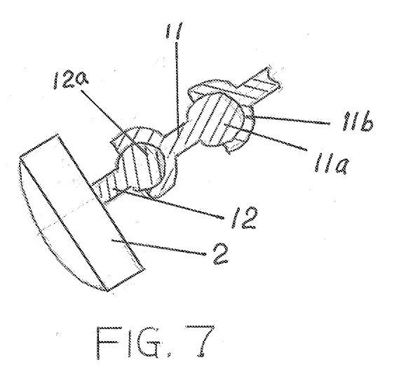

Please refer to FIGS. 1, 2, 3, 4, 5, 6 and 7. An interior side mirror for side blind spot 1 comprises an anchor base 4, a ball-socket joint flexible bar 3 and a mirror 2.

The anchor base 4 has a plate 7, a neck 6 is on the plate 4 and a connecting ball 5 is on the neck, a plurality of anchor legs (8 and 9) are extended from a back of the plate 7, the plurality of legs (8 and 9) are inserted into an side AC vent window 10 to fix the anchor base 4 therein.

The flexible bar 3 is a ball-socket joint flexible bar, which is assembled by a plurality of ball-socket joints 11, each ball-socket 11 has a ball 11a and a recess 11b, the plurality of ball-socket joints 11 are connected together by the balls 11a inserting into the recesses 11b respectively. The connecting ball 5 of the anchor base 4 can be inserted into the recess 11b of the ball-socket joint flexible bar, then the bar and base are connected together.

The back of the mirror 2 is fixed a ball-socket 12 with a ball 12a, which is inserted into the recess 11b of the ball-socket joint flexible bar 3 to connect the interior side mirror 2 theiron.

The mirror 2 can be adjusted at a best position for viewing the blind spot by the driver.

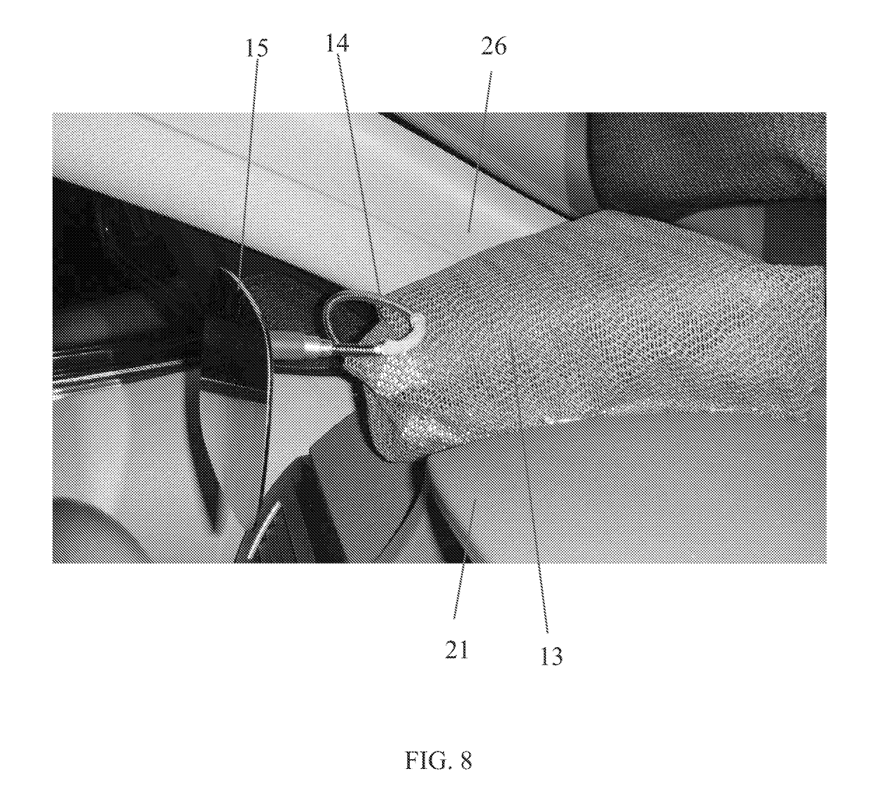

Please refer to the FIG. 8. An interior side mirror for side blind spot 26 comprises a sand bag base 13, a flexible metal conduit bar 14 and a mirror 15.

The sand bag base 13 is made by cloth wrapping up sand. The flexible metal conduit bar is fixed with the sand bag base 13 at firs end and fixed with the mirror 14 at second end. The sand bag base 13 is set on the dash board 21.

The mirror 15 can be adjusted at a best position for viewing the blind spot by the driver.

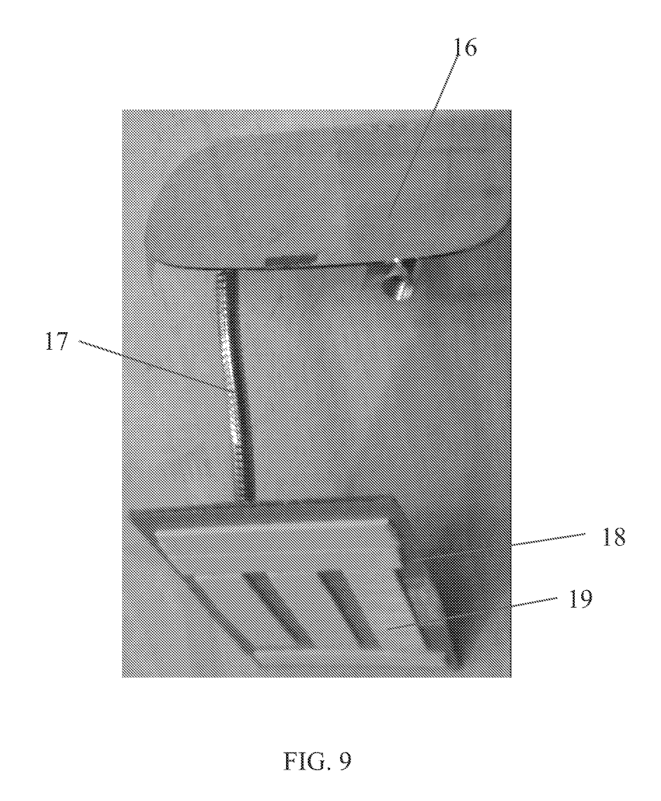

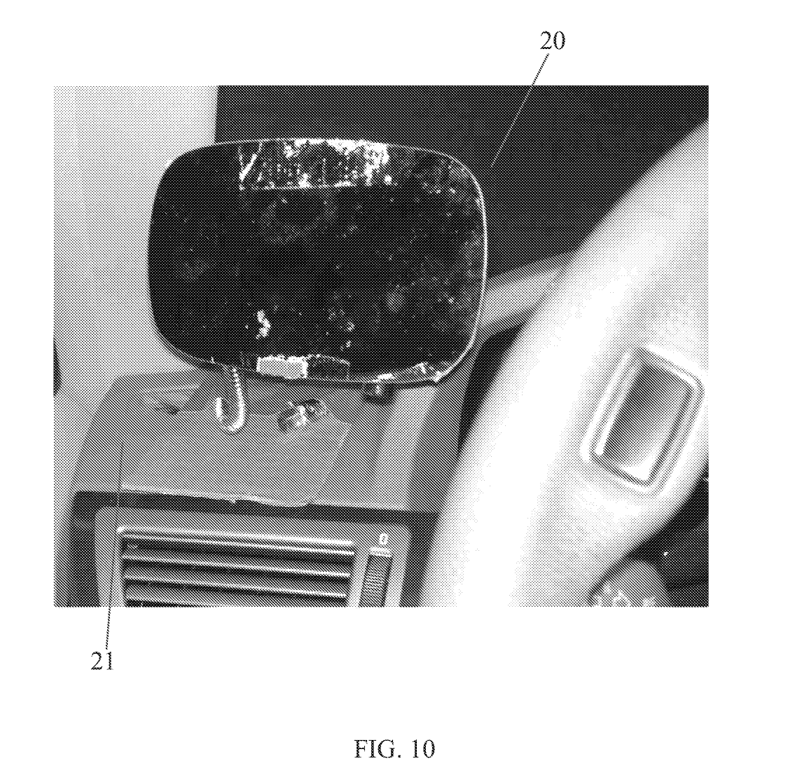

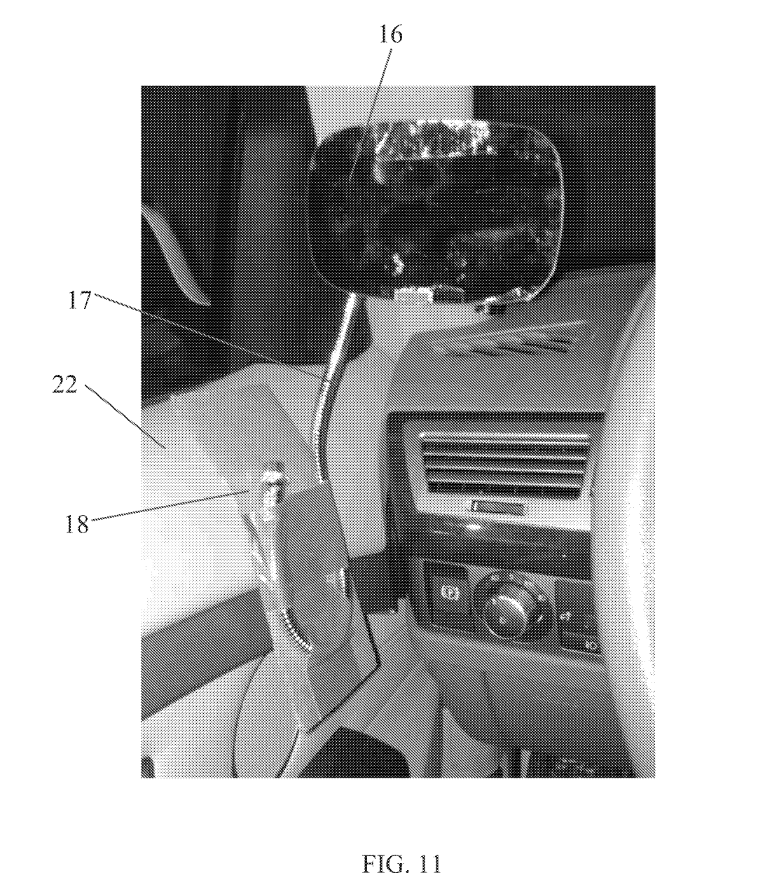

Please refer to the FIGS. 9, 10 and 11. An interior side mirror for side blind spot 20 comprises a cardboard base 18, a flexible metal conduit bar 17 and a mirror 16. The cardboard base 18 has adhesive tapes 19 on its back face.

The mirror 16 is fixed on first end of the flexible metal conduit bar 17, second end of the flexible metal conduit bar 17 is fixed on the cardboard base 18, which is stuck on the dash board 21 or the side door 22 by the adhesive tapes 19.

The mirror 16 can be adjusted at a best position for viewing the blind spot by the driver.

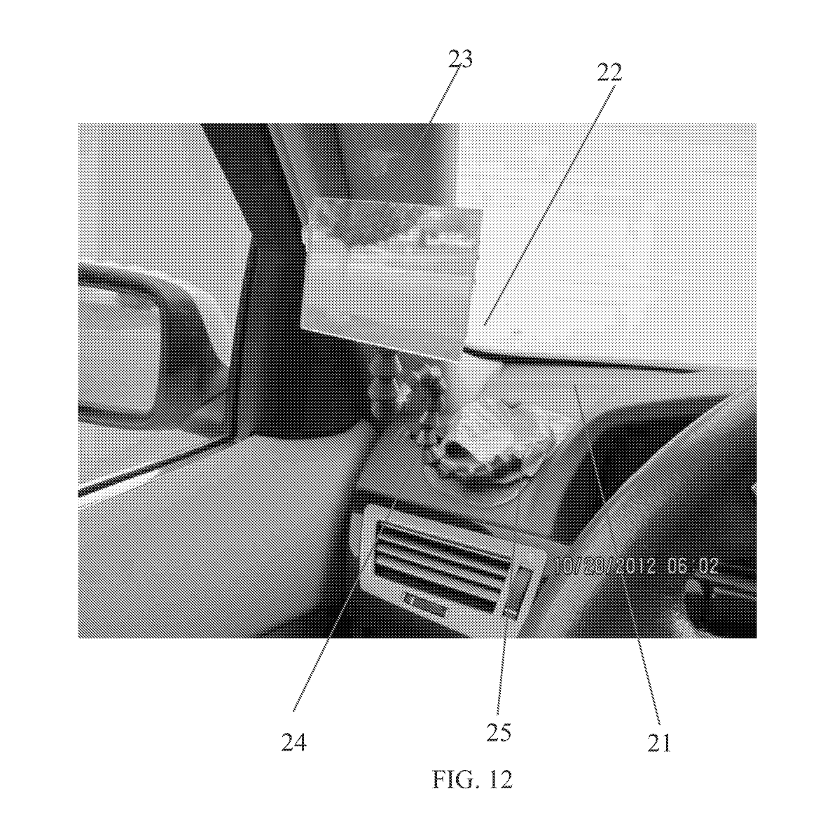

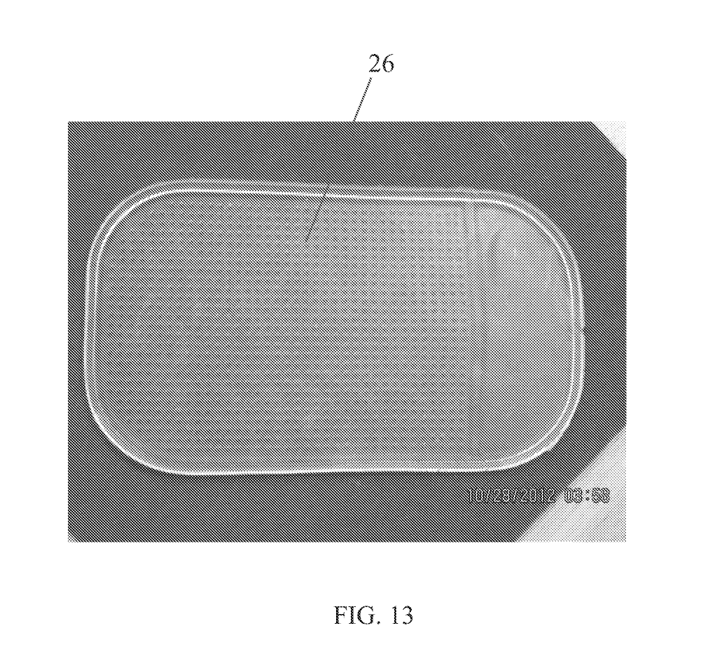

Please refer to the FIGS. 12 and 13. An interior side mirror for side blind spot 22 comprises a silicone sticky pad base 25, a ball-socket joint flexible bar 24 and a mirror 23. The silicone sticky pad base 25 has a silicone sticky pad 26, which is very sticky and secure without getting loosened up easily at all once applied. Another good property is that when peeled off, it doesn't leave any residuals on the surface that it was stuck onto. This silicone is sold in market.

The mirror 23 is fixed on first end of the ball-socket joint flexible bar 24 , second end of ball-socket joint flexible bar 24 is fixed on the silicone sticky pad base 25, which is stuck on the dash board 21.

The mirror 23 can be adjusted at a best position for viewing the blind spot by the driver.

What is claimed is:

1. An interior side mirror for side blind spot of a car comprising:
a base fixed on an interior part of the car before a driver;
a side mirror;
a flexible bar for connecting the base with the side mirror; and
the base cooperating the flexible bar to locate the mirror at a best place for the driver viewing the side blind spot from the interior side mirror without tuning head.

2. The interior side mirror for side blind spot of a car of claim 1, wherein the base is an anchor base, which has a plate, a connecting ball is a neck protruded from the plate, a plurality of anchor legs are extended from a back of the plate, the plurality of legs are inserted into an side AC vent window to fix the anchor base therein.

3. The interior side mirror for side blind spot of a car of claim 2, wherein the flexible bar is a ball-socket joint flexible bar, which is assembled by a plurality of ball-socket joints, each ball-socket has a ball and a recess, the plurality of ball-socket joints are completed by the balls inserting into the recesses in proper order and respectively.

4. The interior side mirror for side blind spot of a car of claim 3, wherein a back of the side mirror has a ball-socket with a ball, which is inserted into the recess of the ball-socket joint flexible bar to connect the side mirror theirin.

5. The interior side mirror for side blind spot of a car of claim 1, wherein the base is a sand bag base, which is sit on a dash board beside the driver, the side mirror is fixed on a flexible metal conduit bar which is fixed on the flexible sand bag.

6. The interior side mirror for side blind spot of a car of claim 1, wherein the base is a cardboard base having adhesive tapes, the side mirror is fixed on a flexible metal conduit which is fixed on the cardboard base.

7. The interior side mirror for side blind spot of a car of claim 6, wherein the cardboard base is stuck on a side door of the car, or a dash board beside the driver.

8. The interior side mirror for side blind spot of a car of claim 1, wherein the base is a silicone sticky pad, which is stuck on a dash board beside the driver, the side mirror is fixed on a ball-socket joint flexible bar which is fixed on the silicone sticky pad base.
